(19) United States
(12) Patent Application Publication
(10) Pub. No.: US 2020/0359412 A1
(43) Pub. Date: Nov. 12, 2020

(54) COMMUNICATION UNIT AND COMMUNICATION SYSTEM

(71) Applicant: SONY SEMICONDUCTOR SOLUTIONS CORPORATION, Atsugi-shi, Kanagawa (JP)

(72) Inventor: Kentaro NAKAHARA, Kanagawa (JP)

(73) Assignee: Sony Semiconductor Solutions Corporation, Atsugi-shi, Kanagawa (JP)

(21) Appl. No.: 16/630,070

(22) PCT Filed: Jun. 12, 2018
(86) PCT No.: PCT/JP2018/022323

§ 371 Date: Jan. 10, 2020

(30) Foreign Application Priority Data
Jul. 19, 2017 (JP) 2017-139990

(51) Int. Cl. H04W 74/04; H04W 74/02; H04W 72/04; H04B 13/00; H04W 52/02; H04W 28/02

(52) U.S. Cl. CPC H04W 74/04; H04W 74/02; H04W 28/02; H04B 13/005; H04W 52/0216; H04W 72/0446

(57) ABSTRACT

A communication unit according to the present disclosure includes a communication circuit section that transmits and receives data to and from at least one communication target unit over a period of a plurality of time segments each divided into a plurality of time slots, receives data transmitted from the communication target unit during a period of a time slot assigned to the communication target unit out of each of the communication target units, and transmits data to the at least one communication target unit during a period of a time slot that differs from the time slot assigned to the communication target unit out of each of the communication target units, and a controller that, in a case where the at least one communication target unit enters a sleep period during which the at least one communication target unit temporarily suspends transmission operation, controls, during the sleep period, the communication circuit section to transmit data during the period of the time slot assigned to the communication target unit, in place of the at least one communication target unit.

### TECHNICAL FIELD

The present disclosure relates to a communication unit and a communication system that perform communication on the basis of a time division scheme.

### Background Art

A communication system based on a general TDMA (Time Division Multiple Access) scheme has a plurality of personal stations each transmitting data during a period of a different time slot assigned to each of them. The communication system based on the general TDMA scheme has a cell station that manages the personal stations, and the cell station manages the time slots used by the respective personal stations to avoid occurrence of collision in communication among the personal stations. Meanwhile, a communication system using electric field communication technology in which, for example, a human body is used as a communication medium is known. Although, depending on the communication standard, the communication system using electric field communication technology may perform communication in a time division manner, it may have no cell station for managing time slots used by personal stations.

### CITATION LIST

### Patent Literature

PTL 1: WO 2010/029593

### SUMMARY OF THE INVENTION

In a case of a communication standard having no cell station for managing time slots used by personal stations in the time division scheme, if, for example, a certain personal station enters a temporary sleep state and returns from the sleep state, a time slot that has been used by the personal station before it enters the sleep state is used by another personal station, and communication collision may occur.

It is desirable to provide a communication unit and a communication system that enable to enter a temporary sleep state while avoiding communication collision.

A communication unit according to an embodiment of the present disclosure includes a communication circuit section that transmits and receives data to and from at least one communication target unit over a period of a plurality of time segments each divided into a plurality of time slots, receives data transmitted from the communication target unit during a period of a time slot assigned to the communication target unit out of each of the communication target units, and transmits data to the at least one communication target unit during a period of a time slot that differs from the time slot assigned to the communication target unit out of each of the communication target units, and a controller that, in a case where the at least one communication target unit enters a sleep period during which the at least one communication target unit temporarily suspends transmission operation, controls, during the sleep period, the communication circuit section to transmit data during the period of the time slot assigned to the communication target unit, in place of the at least one communication target unit.

A communication system according to an embodiment of the present disclosure includes a plurality of communication units, each of the plurality of communication units including a communication circuit section that transmits and receives data to and from at least one communication target unit over a period of a plurality of time segments each divided into a plurality of time slots, receives data transmitted from the communication target unit during a period of a time slot assigned to the communication target unit out of each of the communication target units, and transmits data to the at least one communication target unit during a period of a time slot that differs from the time slot assigned to the communication target unit out of each of the communication target units, and a controller that, in a case where the at least one communication target unit enters a sleep period during which the at least one communication target unit temporarily suspends transmission operation, controls, during the sleep period, the communication circuit section to transmit data during the period of the time slot assigned to the communication target unit, in place of the at least one communication target unit.

In the communication unit or the communication system according to an embodiment of the present embodiment, in a case where the at least one communication target unit enters the sleep period during which it temporarily suspends the transmission operation, during the sleep period, transmission of data is performed during the period of the time slot assigned to the communication target unit, in place of the at least one communication target unit.

According to the communication unit or the communication system of an embodiment of the present embodiment, in a case where at least one communication target unit enters a sleep period, data transmission is performed during a period of a time slot assigned to the communication target unit, in place of the at least one communication target unit. Therefore, it is possible for the communication target unit to enter a temporary sleep state while avoiding communication collision.

It should be noted that the effects described herein are not necessarily limited, and any effect described in the present disclosure may be obtained.

### BRIEF DESCRIPTION OF DRAWING

FIG. 1 is an explanatory diagram illustrating an outline of communication operations by a communication system according to a comparative example based on a general TDMA scheme.

FIG. 2 is an explanatory diagram illustrating an example of a transmission format according to the CCCC-PHY standard.

FIG. 3 is an explanatory diagram illustrating an outline of communication operations by a communication system according to a comparative example using the CCCC-PHY standard.

FIG. 4 is an explanatory diagram illustrating an outline of communication operations by a communication system according to a first embodiment of the present disclosure.

FIG. 5 is a flowchart schematically illustrating an example of a control flow by the communication system during a sleep state according to the first embodiment.

FIG. 6 is a block diagram schematically illustrating a configuration example of a communication unit according to the first embodiment of the present disclosure.

FIG. 7 is a configuration diagram illustrating an outline of a communication system using a human body as a communication medium.

FIG. 8 is an explanatory diagram illustrating an outline of the communication system using the human body as the communication medium.

FIG. 9 is a block diagram depicting an example of schematic configuration of a vehicle control system.

FIG. 10 is a diagram of assistance in explaining an example of installation positions of an outside-vehicle information detecting section and an imaging section.

### MODES FOR CARRYING OUT THE INVENTION

Embodiments of the present disclosure will be described in detail below with reference to the drawings. Further, the description will be given in the following order.

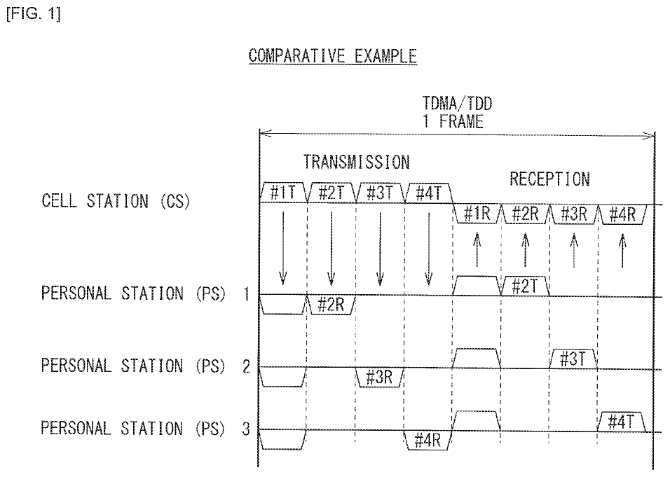

### 0. Comparative Example (FIGS. 1 to 3)

### 1. First Embodiment

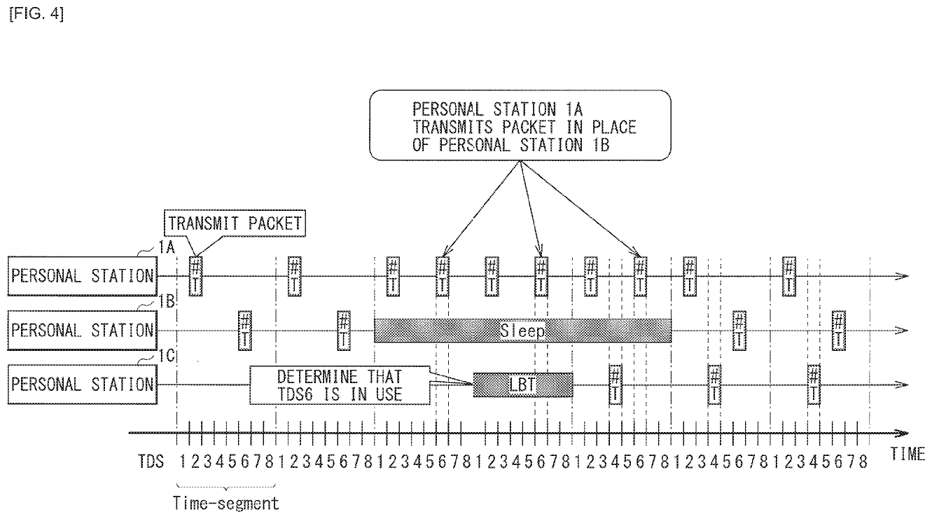

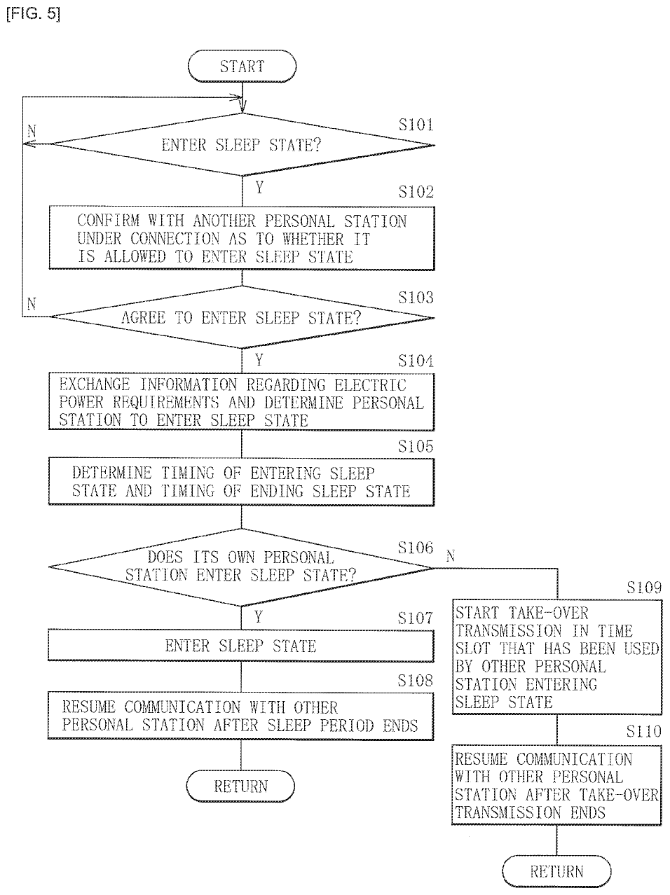

### 1.1 Outline of Communication System (FIGS. 4 and 5)

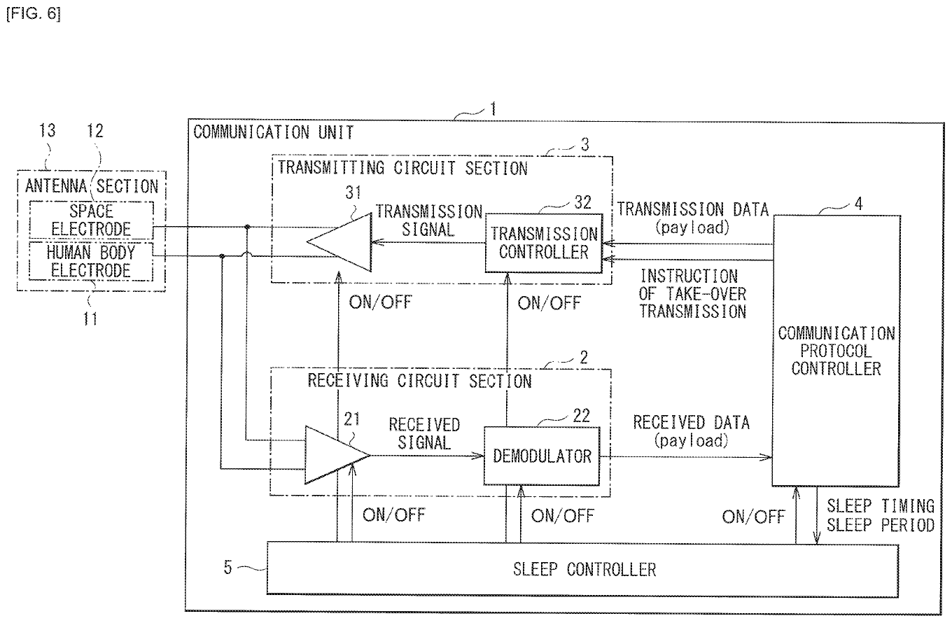

### 1.2 Specific Example of Communication Unit (FIG. 6)

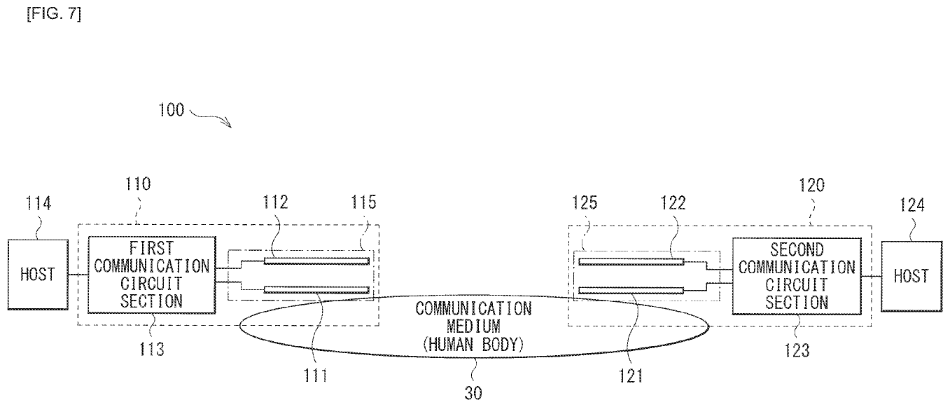

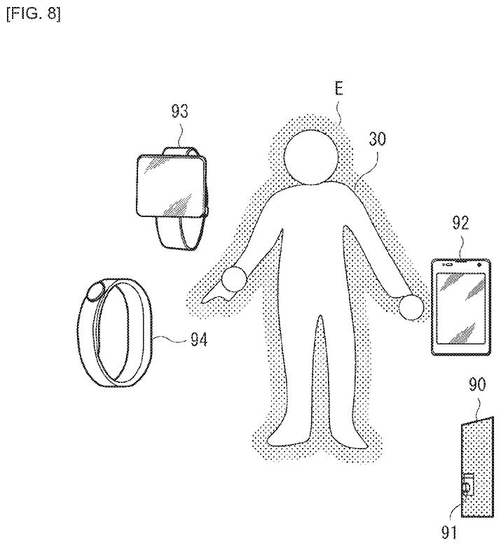

### 1.3 Outline of Communication System Using Human Body as Communication Medium (FIGS. 7 and 8)

### 1.4 Effects

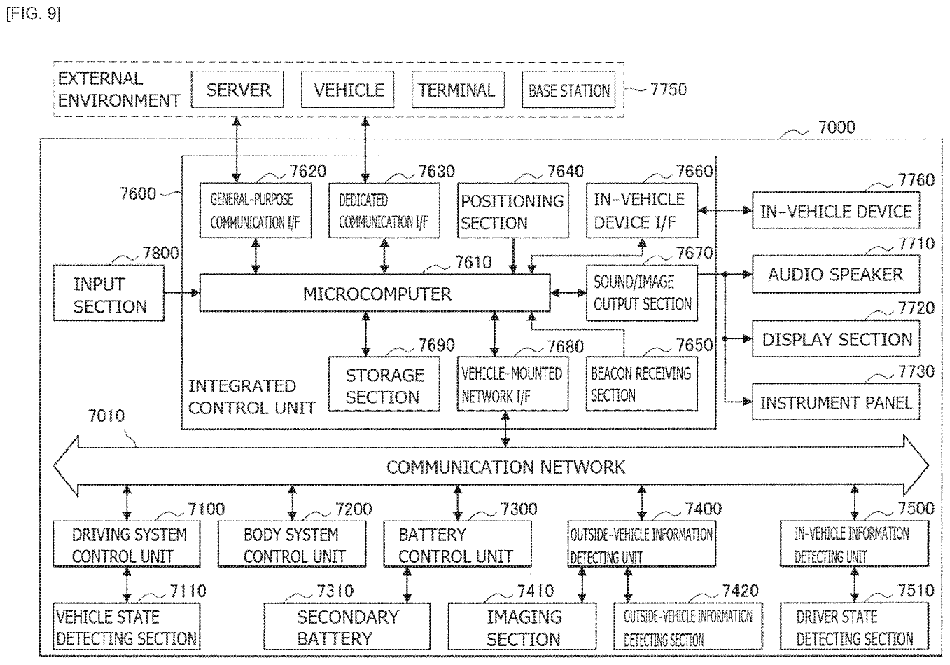

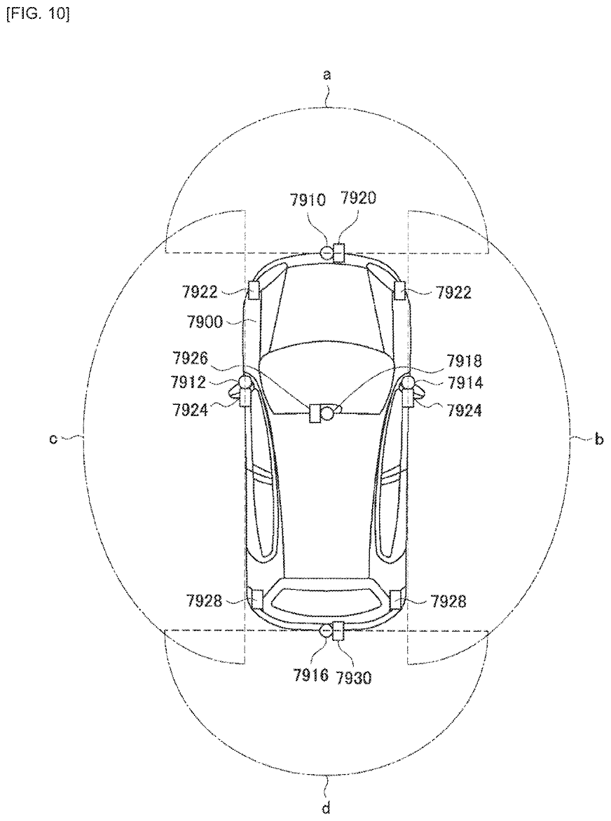

### 2. Second Embodiment (Application Example) (FIGS. 9 and 10)

### 3. Other Embodiments

### 0. Comparative Example

### (Communication System Based on General TDMA Scheme)

FIG. 1 illustrates an outline of communication operations by a communication system according to a comparative example based on a general TDMA scheme.

FIG. 1 illustrates a communication system based on a combination of a time division multiple access (TDMA) scheme and a time division dultiplex (TDD: Time Division Dultiplex) scheme. This communication system is adopted in PHS (Personal Handy-Phone System) and the like.

This communication system includes a cell station (CS: Cell Station) and a plurality of personal stations (PS: Personal Station) as a communication unit.

This communication system divides one communication frame into a plurality of time slots and assigns a different time slot to each personal station, and the cell station and each personal station alternately transmit and receive data at different timings using the same frequency. In a general TDMA system, the cell station administers and controls the time slots. For example, PHS adopts a four-channel multiplex multicarrier TDMA-TDD scheme as illustrated in FIG. 1. In FIG. 1, #1T, #2T, #3T, and #4T indicate transmitting time slots, and #1R, #2R, #3R, and #4R indicate receiving time slots.

In the example of FIG. 1, for example, a communication frame of 5 ms is divided into eight time slots, and four time slots are allocated for the downlink direction (from the cell station to each personal station), and four time slots are allocated for the uplink direction (from each personal station to the cell station). Among the time slots in the respective directions, the time slots #1T and #1R are used as control channels, and the remaining #2T, #3T, and #4T and #2R, #3R, and #4R are used as communication channels.

(Transmission Format according to CCCC-PHY Standard)

Standardized specifications for the communication system using electric field communication technology include ISO/IEC 17982 CCCC PHY (Closed Capacitive Coupling Communication Physical Layer). The ISO/IEC 17982 CCCC PHY (hereinafter referred to as CCCC-PHY) adopts automatic retransmission control (ARQ; Automatic Repeat reQuest) using an error detection code and retransmission control.

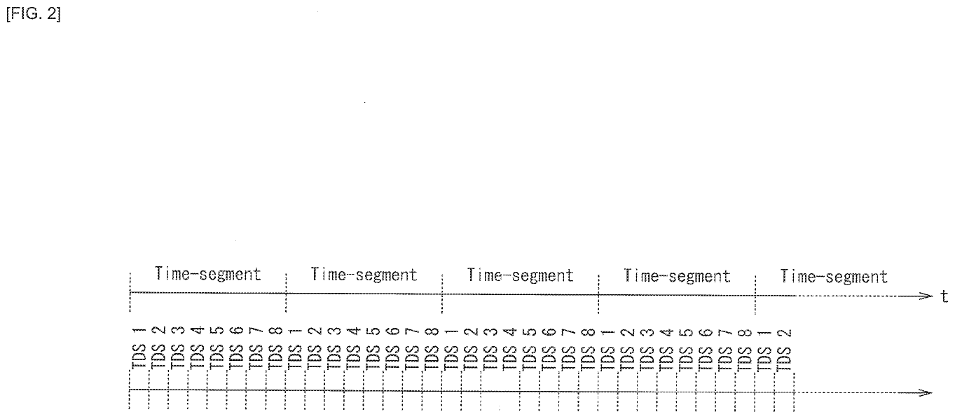

FIG. 2 illustrates an example of a transmission format according to the CCCC-PHY standard.

In the CCCC-PHY standard, transmission data is transmitted between at least one communication target unit and a communication unit per time segment (Time-segment) having a predetermined interval. One time segment includes a predetermined number of divisions, that is, a plurality of time slots (Time Slot, TDS (Time Division Slot)).

The communication unit receives transmission data from the communication target unit over a period of a plurality of time segments. The transmission data from the communication target unit is transmitted during a period of one time slot of the plurality of time slots in each of the plurality of time segments. In a case where there is a plurality of communication target units or communication units, in one time segment, a different time slot is assigned to each unit. The time slots are assigned by a communication target unit or a communication unit that starts communication first.

The transmission data transmitted during a period of one time slot is packet data. The packet data includes a preamble (Pre amble), synchronization (Sync) data, attribute (Attribute) data, a TDS Number, and a Sequence Number (retransmission number). The packet data also includes Payload which is actual data of the transmission data and CRC (Cyclic Redundancy Check) as an error detection code.

### Problems

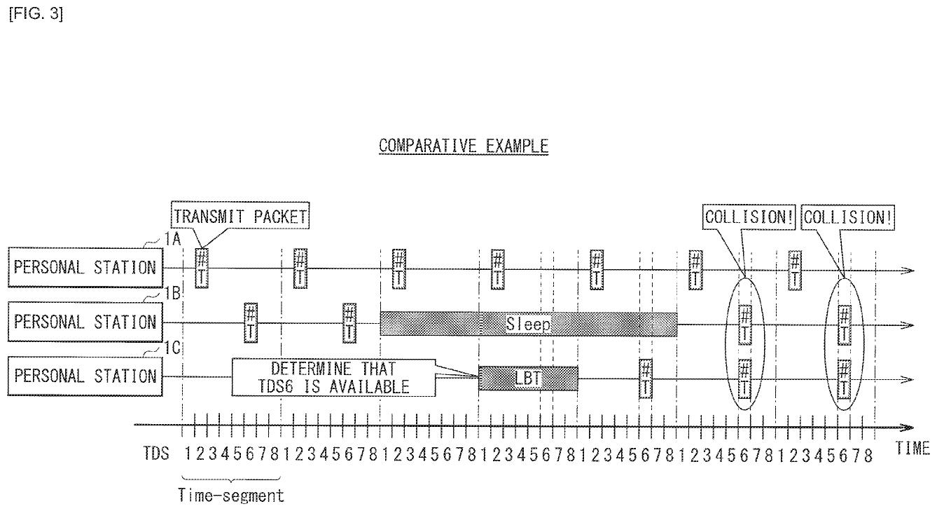

FIG. 3 illustrates an outline of communication operations by a communication system according to a comparative example using the CCCC-PHY standard. FIG. 3 illustrates an example having three personal stations, a personal station 1A, a personal station 1B, and a personal station 1C as communication target units or communication units. In FIG. 3, #T indicates a transmitting time slot.

In the CCCC-PHY standard communication system, during a period of one time segment (TDS), in a time slot other than time slots assigned to one personal station and another personal station, yet another personal station may perform communication. In order to avoid occurrence of signal interference among these personal stations, it is necessary to continue to maintain timings of time slots appropriately among them.

However, in the CCCC-PHY standard communication system, there is no cell station that collectively manages the time slots. In the CCCC-PHY standard communication system, the personal stations use the time slots on a first come first served basis. A time slot that is already being used by one personal station is detected by another personal station by using a mechanism called LBT (Listen Before Talk). This allows the other personal station to detect that one personal station is performing packet transmission before the other personal station starts transmission, thereby preventing communication collision.

In the CCCC-PHY standard communication system, there is a possibility that, if a packet is not being transmitted in a time slot which has been used by one personal station, and the other personal station performs LBT, the time slot is judged to be available and is used as a time slot for the other personal station. Therefore, to prevent its own time slot from being used by the other personal station, it is necessary for one personal station to continue transmitting packets even when it temporarily has no data to transmit. For example, even in a case where the personal station temporarily has no data to transmit, and thus may desire to enter a sleep state (low power state or temporary standby state) and resume communication upon generation of data to be transmitted again, the personal station is not able to enter a sleep state in order to ensure its time slot and consumes unnecessary power.

For example, in FIG. 3, at first, the personal station 1A uses time slots of TDS2, and the personal station 1B uses time slots of TDS6 to transmit data to each other. The personal station 1B then stops transmission and enters a temporary sleep state (Sleep). It then resumes transmission in time slots of TDS6.

Here, there is a possibility that, if another personal station (personal station 1C) performs LBT while the personal station 1B is in the sleep state, the other personal station determines that the time slots of TDS6, which have been used by the personal station 1B, are available. As a result, after the sleep period of the personal station 1B ends, the personal station 1B and the personal station 1C perform transmission in the same time slots of TDS6, and communication collision occurs.

In light of the above, it is desirable to develop a technique that enables a communication unit and a communication system according to the CCCC-PHY standard to enter a temporary sleep state while avoiding communication collision.

### 1. First Embodiment

### 1.1 Outline of Communication System

A communication system according to the present embodiment includes a plurality of communication units. Each of the plurality of communication units includes a communication circuit section that transmits and receives data to and from at least one communication target unit over a period of a plurality of time segments each divided into a plurality of time slots, and a controller that controls the communication circuit section. [0029] The communication circuit section receives data transmitted from the communication target unit during a period of a time slot assigned to the communication target unit out of each of the communication target units, and transmits data to the at least one communication target unit during a period of a time slot that differs from the time slot assigned to the communication target unit out of each of the communication target units.

In a case where the at least one communication target unit enters a sleep period during which it temporarily suspends transmission operation, the controller controls, during the sleep period, the communication circuit section to transmit data during the period of the time slot assigned to the communication target unit, in place of the at least one communication target unit.

FIG. 4 illustrates an outline of communication operations by the communication system according to the present embodiment. Although, as in the comparative example in FIG. 3, FIG. 4 illustrates an example having three personal stations, a personal station 1A, a personal station 1B, and a personal station 1C as communication target units or communication units, the number of personal stations may be two or may be four or more.

Hereinafter, performing packet transmission by one personal station in a time slot that has been used by another personal station which is in a sleep state, in place of the other personal station in the sleep state, will be referred to as “take-over transmission”.

For example, in FIG. 4, at first, the personal station 1A uses time slots of TDS2, and the personal station 1B uses time slots of TDS6 to transmit data to each other. The personal station 1B then stops transmission and enters a temporary sleep state (Sleep). It then resumes transmission in time slots of TDS6.

Here, the other personal station that has been communicating with the personal station entering the sleep state, performs transmission also in the time slots that have been used by the personal station entering the sleep state, thereby preventing the time slots from being used by another personal station. In the example of FIG. 4, during the sleep period of the personal station 1B, the personal station 1A transmits data during a period of the time slots of TDS6 assigned to the personal station 1B, in place of the personal station 1B. That is, the personal station 1A performs take-over transmission for the personal station 1B during the sleep period of the personal station 1B.

If another personal station (personal station 1C) performs LBT while the personal station 1B is in the sleep state, the time slots of TDS6, which have been used by the personal station 1B, are being used by the personal station 1A for take-over transmission and are therefore determined to be in use. As a result, the personal station 1C uses, as its time slots, TDS4, for example, which differ from the time slots originally used by the personal station 1A (TDS2) and the time slots taken over by the personal station 1A (TDS6). Consequently, after the sleep period of the personal station 1B ends, the personal station 1B and the personal station 1C do not perform transmission in the same time slots of TDS6, whereby it is possible to avoid communication collision.

Thus, it becomes possible for the personal station 1B to enter a sleep state while avoiding communication collision, and it is possible to achieve reduction in power consumption in the entire communication system. Although, during the sleep period of the personal station 1B, it is necessary for the personal station 1A to perform transmission also in the time slots (TDS6), which differ from its original time slots (TDS2), this does not cause a large increase in electric power because a BAN (Body Area Network) or the like according to the CCCC-PHY standard only necessitates a small amount of electric power for transmission.

FIG. 5 schematically illustrates an example of a control flow by the communication system during the sleep state according to the present embodiment.

Here, operations performed by the personal station 1B during its connection (during its communication) with the personal station 1A, which is the other personal station, will be described as an example.

The personal station 1B determines whether or not to enter a sleep state (step S101). In a case where the personal station 1B determines not to enter the sleep state (step S101; N), it repeats the processing in S101 at predetermined intervals.

In a case where the personal station 1B determines to enter the sleep state (step S101; Y), it confirms with the other personal station (personal station 1A), which is connected to the personal station 1B, as to whether or not the personal station 1B is allowed to enter the sleep state (step S102).

Next, the personal station 1B determines whether or not an agreement has been reached with the other personal station to enter the sleep state (step S103). In a case where the personal station 1B determines that the agreement about entering the sleep state has not been reached (step S103; N), the personal station 1B returns the processing in step S101.

Meanwhile, in a case where the personal station 1B determines that the agreement about entering the sleep state has been reached (step S103; Y), the personal station 1B exchanges information regarding electric power requirements with the other personal station and determines a personal station to enter the sleep state (step S104). Here, the electric power requirements refer to battery capacity, remaining battery charge, and the like. For example, the personal station 1B determines a personal station with a smaller amount of battery capacity or remaining battery charge as the personal station to enter the sleep state. This allows the personal station with less power to spare to enter the sleep state and the personal station with more power to spare to perform take-over transmission.

Next, the personal station 1B determines a timing of entering the sleep state (sleep timing) and a timing of ending the sleep state (step S105). The timing of ending the sleep state may be a period during which sleep is performed (sleep period).

Next, the personal station 1B determines whether or not the personal station 1B itself enters the sleep state (step S106). In a case where it determines that personal station 1B itself enters the sleep state (step S106; Y), the personal station 1B enters the sleep state at the determined sleep timing (step S107). After the determined sleep period ends, the personal station 1B resumes communication with the other personal station (step S108). The personal station 1B may then return to the processing in step S101.

On the other hand, in a case where the personal station 1B determines that the personal station 1B itself does not enter the sleep state (the other personal station enters the sleep state) (step S106; N), the personal station 1B performs take-over transmission in the time slots that have been used by the other personal station entering the sleep state (step S109). After the period during which take-over transmission is performed (which is the sleep period for the other personal station) ends, the personal station 1B resumes communication with the other personal station (step S110). The personal station 1B may then return to the processing in step S101.

It should be noted that, although, in the above description, in order to simplify the description, the operations performed during communication between the two personal stations have been described as an example, it is also possible to perform the similar operations during communication among three or more personal stations. For example, in a case where the personal station 1B in FIG. 4 enters the sleep state while it is connected to (communicates with) the personal station 1A and the personal station 1C, either one of the personal station 1A and the personal station 1C is able to perform take-over transmission for the personal station 1B.

In addition, for example, one personal station is able to perform take-over transmission for two or more personal stations. For example, in a case where the personal station 1B and the personal station 1C in FIG. 4 enter the sleep state while they are connected to (communicate with) the personal station 1A, the personal station 1A is able to perform take-over transmission for the personal station 1B and the personal station 1C.

[1.2 Specific Example of Communication Unit] FIG. 6 schematically illustrates a configuration example of a communication unit 1 according to the first embodiment of the present disclosure.

For example, each of the personal station 1A, the personal station 1B, and the personal station 1C in FIG. 4 may include the communication unit 1 illustrated in FIG. 6. The communication unit 1 illustrated in FIG. 6 may also be applied as communication units of a communication system 100 (FIG. 7) described below which uses a human body as a communication medium.

The communication unit 1 is able to perform communication, for example, in a transmission format conforming to the CCCC-PHY standard illustrated in FIG. 3.

The communication unit 1 may have an antenna section 13. The antenna section 13 may be externally attached to the communication unit 1.

The communication unit 1 includes a receiving circuit section 2 that receives reception data from a communication target unit via the antenna section 13, and a transmitting circuit section 3 that transmits transmission data to the communication target unit via the antenna section 13. The receiving circuit section 2 and the transmitting circuit section 3 may be a communication circuit section as a whole. The communication unit 1 also includes a communication protocol controller 4 and a sleep controller 5.

In a case where the communication unit 1 is applied to the communication system 100 (FIG. 7) described below, which uses a human body as a communication medium, the antenna section 13 may include a human body electrode 11 and a space electrode 12.

The receiving circuit section 2 includes a receiving circuit 21 and a demodulator 22. The receiving circuit 21 may include a receiving amplifier, a filter, an ADC (A/D converter), and the like. The demodulator 22 transmits reception data (Payload) to the communication protocol controller 4.

The transmitting circuit section 3 includes a transmitting circuit 31 and a transmission controller 32. The transmitting circuit 31 may include a transmitting amplifier and the like. The communication protocol controller 4 transmits transmission data (Payload) to the transmission controller 32.

The transmission controller 32 performs transmission in a designated time slot in accordance with an instruction from the communication protocol controller 4. The transmission controller 32 has not only a transmitting function in time slots used by its own personal station but also a transmitting function in time slots used by another personal station for which its own personal station takes over communication. The transmission controller 32 transmits, for example, dummy data in the time slot for take-over transmission. For example, in a case where the transmission format conforms to the CCCC-PHY standard, the transmission controller 32 transmits a Null P-PDU (PHY-Protocol Data Unit).

The communication protocol controller 4 exchanges transmission and reception data with the other personal station to which its own personal station is connected. The communication protocol controller 4 has a function of confirming with the other personal station as to whether or not the other personal station is allowed to enter the sleep state (step S102 in FIG. 5).

The communication protocol controller 4 also has a function of judging which of its own personal station and the other personal station is to enter the sleep state, on the basis of the information regarding electric power requirements (steps S104 and S106 in FIG. 5).

The communication protocol controller 4 also has a function of exchanging information regarding a sleep timing and a sleep period with the other personal station. The communication protocol controller 4 also has a function of performing control, in a case where its own personal station is to enter the sleep state, to determine the sleep timing and the sleep period (step S105 in FIG. 5). The communication protocol controller 4 also has a function of performing control to resume communication with the other personal station after the sleep period ends (steps S108 and S110 in FIG. 5).

The sleep controller 5 performs control in a case where its own personal station enters the sleep state. The sleep controller 5 manages the timing of entering the sleep state and the timing of exiting from the sleep state.

The sleep controller 5 controls ON/OFF of each of the receiving circuit 21, the demodulator 22, the transmitting circuit 31, the transmission controller 32, and the communication protocol controller 4. The sleep controller 5 turns each of the components to an OFF state, thereby turning its own personal station into the sleep state and turning its own personal station into a low power state.

After the sleep period ends, the sleep controller 5 returns each of the components to the ON state to control them to exit from the sleep state.

Further, even in a case where the personal station performs take-over transmission for the other personal station, the other personal station enters the sleep state, and therefore, the sleep controller 5 may turn the receiving circuit 21, the demodulator 22, and the communication protocol controller 4 to the OFF state to turn part of the components into the sleep state.

### [1.3 Outline of Communication System Using Human Body as Communication Medium]

FIG. 7 and FIG. 8 illustrate an outline of the communication system 100 using a human body 30 as a communication medium, in which electric field communication technology is used.

This communication system 100 has a first communication unit 110 and a second communication unit 120.

The communication unit 1 illustrated in FIG. 6 may be applied as the first communication unit 110 and the second communication unit 120 in the communication system 100 in FIG. 7. In this case, the first communication unit 110 and the second communication unit 120 may be transmitting and receiving units that bidirectionally transmit and receive data. Either one of the first communication unit 110 and the second communication unit 120 may be a communication target unit, and the other one of them may be a communication unit that communicates with the communication target unit.

The communication system 100 may be used for communication, for example, between a communication device installed in wearable equipment, such as a smart watch 93 and a wrist band terminal 94, and a communication device installed in a door knob 91 of a door 90, a smartphone 92, and the like, as illustrated in FIG. 8. For example, either one of the first communication unit 110 and the second communication unit 120 may be provided in the smart watch 93 or the like, and the other one of them may be provided in the smartphone 92 or the like. The communication system 100 may also be used to unlock automobile doors, etc. For example, either one of the first communication unit 110 and the second communication unit 120 may be provided in automobile doors. The communication system 100 may also be used, for example, to unlock, in addition to the automobile doors, the door 90 which has a locking function and is used to enter and leave a room.

The first communication unit 110 has a first antenna section 115 and a first communication circuit section 113. The first antenna section 115 has a first human body electrode 111 and a first space electrode 112 as communication electrodes. The first communication circuit section 113 is connected to a host 114.

The second communication unit 120 has a second antenna section 125 and a second communication circuit section 123. The second antenna section 125 has a second human body electrode 121 and a second space electrode 122 as communication electrodes. The second communication circuit section 123 is connected to a host 124.

Each of the first communication circuit section 113 and the second communication circuit section 123 includes a communication circuit according to the electric field communication method (quasi-electrostatic field communication method).

The first communication circuit section 113 may include at least a transmitting circuit (transmitting unit). The second communication circuit section 123 may include at least a receiving circuit (receiving unit). Further, each of the first communication circuit section 113 and the second communication circuit section 123 may have a transmitting and receiving circuit, and bidirectional communication may be possible between the first communication unit 110 and the second communication unit 120.

In a case where the first communication unit 110 transmits a signal, the first communication circuit section 113 generates a transmission signal of a potential difference including a signal modulated by a predetermined modulation method, between the first human body electrode 111 and the first space electrode 112. The first human body electrode 111 is disposed on the side closer to the human body 30 than the first space electrode 112. The first human body electrode 111 is thus disposed to have stronger electrostatic coupling to the communication medium (human body 30) than the first space electrode 112.

In this communication system, a part of the human body 30 comes closer to the second human body electrode 121 than to the second space electrode 122, thereby forming a human body-side communication path between the first human body electrode 111 and the second human body electrode 121 using the human body 30 as a communication medium. A space-side communication path using a space (for example, air) as a communication medium is also formed between the first space electrode 112 and the second space electrode 122.

The second human body electrode 121 and the second space electrode 122 have a potential difference therebetween which is generated on the basis of the transmission signal transmitted via the human body-side communication path and the space-side communication path. The second communication circuit section 123 detects the potential difference generated between the second human body electrode 121 and the second space electrode 122, performs demodulation processing corresponding to the modulation method of the first communication circuit section 113 to obtain a received signal, and output the received signal as an output signal.

In the electric field communication method (quasi-electrostatic field communication method), communication is enabled to be performed when coupling between the human body electrodes of the first communication unit 110 and the second communication unit 120 becomes strong. Communication is enabled to be performed when a person touches the human body electrode. Communication is, however, enabled to be performed even when a person approaches the human body electrode to thereby allow an electric field E to be distributed over the surface of the human body as illustrated in FIG. 8. Therefore, communication is possible only in close proximity of the human body 30. This is highly compatible with wearable devices.

### 1.4 Effects

As described above, according to the present embodiment, in a case where at least one communication target unit enters a sleep period, data transmission is performed during a period of time slots assigned to the communication target unit, in place of the at least one communication target unit. Therefore, it is possible for the communication target unit to enter a temporary sleep state while avoiding communication collision. The personal station entering the sleep state is allowed to enter the sleep state while occupying its own time slots. In a case where a personal station having a large battery and a personal station having a small battery are assumed, an effect of extending the life of the entire system is expectable by causing the personal station having a small battery to enter the sleep state.

It should be noted that the effects described herein are merely examples and are not limited, and that other effects may be obtained. The same applies to the effects of the other embodiments below.

### 2. Second Embodiment (Application Example)

The technology according to the present disclosure is applicable to various products. For example, the technology of the present disclosure may be achieved in the form of an apparatus to be mounted to a mobile body of any kind. Examples of the mobile body include an automobile, an electric vehicle, a hybrid electric vehicle, a motorcycle, a bicycle, a personal mobility, an airplane, a drone, a vessel, a robot, a construction machine, and an agricultural machine (tractor).

FIG. 9 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 9, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 9 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

FIG. 10 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 10 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 9, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automatic driving, which makes the vehicle to travel autonomously without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 9, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 9 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

In the vehicle control system 7000 described above, the communication unit and the communication system according to the present disclosure are applicable to communication, via the general-purpose communication I/F 7620, with the external environment 7750 such as a personal station present near the vehicle, for example. In addition, it is possible to apply them to communication, via the in-vehicle device I/F 7660, with a mobile device of the occupant or with the in-vehicle devices 7760 such as a wearable device.

### 3. Other Embodiments

The technique according to the present disclosure is not limited to the description of the above embodiments, and various modifications are possible.

For example, each component in each of the above embodiments may be divided into a plurality of components, and the plurality of divided components may have different functions.

In addition, for example, in the control flow in each of the above embodiments, a control flow for omitting part of each processing step may be performed. A control flow for adding another processing step that has not been described in the control flow may also be performed. A control flow for partially replacing the order of processing steps illustrated in the control flow may also be performed.

For example, it is possible for the present technology to have the following configurations.

(1)
A communication unit including:
a communication circuit section that transmits and receives data to and from at least one communication target unit over a period of a plurality of time segments each divided into a plurality of time slots, receives data transmitted from the communication target unit during a period of a time slot assigned to the communication target unit out of each of the communication target units, and transmits data to the at least one communication target unit during a period of a time slot that differs from the time slot assigned to the communication target unit out of each of the communication target units; and
a controller that, in a case where the at least one communication target unit enters a sleep period during which the at least one communication target unit temporarily suspends transmission operation, controls, during the sleep period, the communication circuit section to transmit data during the period of the time slot assigned to the communication target unit, in place of the at least one communication target unit.
   (2)
The communication unit according to (1), in which in a case where the communication unit has more power to spare than the at least one communication target unit, the controller causes the communication circuit section to transmit data in place of the at least one communication target unit.
   (3)
The communication unit according to (1) or (2), further including an antenna section including a first electrode and a second electrode, in which the communication circuit section performs, via the antenna section, communication in which a human body serves as a communication medium.
   (4)
A communication system that includes a plurality of communication units, each of the plurality of communication units including:
a communication circuit section that transmits and receives data to and from at least one communication target unit over a period of a plurality of time segments each divided into a plurality of time slots, receives data transmitted from the communication target unit during a period of a time slot assigned to the communication target unit out of each of the communication target units, and transmits data to the at least one communication target unit during a period of a time slot that differs from the time slot assigned to the communication target unit out of each of the communication target units; and
a controller that, in a case where the at least one communication target unit enters a sleep period during which the at least one communication target unit temporarily suspends transmission operation, controls, during the sleep period, the communication circuit section to transmit data during the period of the time slot assigned to the communication target unit, in place of the at least one communication target unit.
   (5)
The communication system according to (4), in which, in a case where the communication unit has more power to spare than the at least one communication target unit, the controller causes the communication circuit section to transmit data in place of the at least one communication target unit.
   (7)
The communication system according to (4) or (5), in which each of the plurality of communication units further includes an antenna section including a first electrode and a second electrode, and
the communication circuit section performs, via the antenna section, communication in which a human body serves as a communication medium.

The present application claims priority based on Japanese Patent Application No. 2017-139990 filed with the Japan Patent Office on Jul. 19, 2017, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A communication unit comprising:
a communication circuit section that transmits and receives data to and from at least one communication target unit over a period of a plurality of time segments each divided into a plurality of time slots, receives data transmitted from the communication target unit during a period of a time slot assigned to the communication target unit out of each of the communication target units, and transmits data to the at least one communication target unit during a period of a time slot that differs from the time slot assigned to the communication target unit out of each of the communication target units; and
a controller that, in a case where the at least one communication target unit enters a sleep period during which the at least one communication target unit temporarily suspends transmission operation, controls, during the sleep period, the communication circuit section to transmit data during the period of the time slot assigned to the communication target unit, in place of the at least one communication target unit.

2. The communication unit according to claim 1, wherein in a case where the communication unit has more power to spare than the at least one communication target unit, the controller causes the communication circuit section to transmit data in place of the at least one communication target unit.

3. The communication unit according to claim 1, further comprising an antenna section including a first electrode and a second electrode, wherein
the communication circuit section performs, via the antenna section, communication in which a human body serves as a communication medium.

4. A communication system that includes a plurality of communication units, each of the plurality of communication units comprising:
a communication circuit section that transmits and receives data to and from at least one communication target unit over a period of a plurality of time segments each divided into a plurality of time slots, receives data transmitted from the communication target unit during a period of a time slot assigned to the communication target unit out of each of the communication target units, and transmits data to the at least one communication target unit during a period of a time slot that differs from the time slot assigned to the communication target unit out of each of the communication target units; and
a controller that, in a case where the at least one communication target unit enters a sleep period during which the at least one communication target unit temporarily suspends transmission operation, controls, during the sleep period, the communication circuit section to transmit data during the period of the time slot assigned to the communication target unit, in place of the at least one communication target unit.

5. The communication system according to claim 4 wherein, in a case where the communication unit has more power to spare than the at least one communication target unit, the controller causes the communication circuit section to transmit data in place of the at least one communication target unit.

6. The communication system according to claim 4, wherein each of the plurality of communication units further comprises an antenna section including a first electrode and a second electrode, and
the communication circuit section performs, via the antenna section, communication in which a human body serves as a communication medium.
